(19) United States
(12) Patent Application Publication
(10) Pub. No.: US 2008/0016880 A1
(43) Pub. Date: Jan. 24, 2008

(54) Gas turbine starter gear shaft and method of manufacture

(76) Inventors: Vittorio Bruno, Mississauga (CA); Nasr Kenawy, Brampton (CA)

Correspondence Address: OGILVY RENAULT LLP (PWC), 1981 MCGILL COLLEGE AVENUE, SUITE 1600, MONTREAL, QC, H3A 2Y3, US

(21) Appl. No.: 11/491,106

(22) Filed: Jul. 24, 2006

(51) Int. Cl. F02C 7/32

(52) U.S. Cl. 60/802

(57) ABSTRACT

A gear shaft for a gearbox, the gear shaft having a spiral bevel gear integral and concentric therewith with portions of the gear shaft extending from each side of the spiral bevel gear, the spiral bevel gear having a negative helix angle.

### TECHNICAL FIELD

The invention relates generally to gas turbine engines and, more particularly, to an improved accessory gearbox for such engines.

### BACKGROUND OF THE ART

In a gas turbine engine, it is known to provide an accessory gearbox which is driven by a drive shaft of the engine and drives a plurality of accessories such as, for example, oil pumps, hydraulic pumps, fuel controls, etc. Usually, the gearbox includes a gear shaft having a standard spiral gear (i.e. with a positive helix angle) integral and concentric therewith, the spiral gear being meshed with a pinion which is indirectly driven by the central shaft of the engine. However, and as shown in FIG. 4, the relative size of the gear shaft 44′ and spiral gear 46′ is usually such that the tool(s) 52′ used to machine the spiral gear 46′ interfere with the shaft 44′. As such, the spiral gear is usually manufactured separately from the shaft and then connected thereto, with for example splines, spigots, retention nuts or a weld. This increases the costs of manufacturing the gearbox and defines a weakness point at the joint between the shaft and the spiral gear.

Accordingly, improvements are desirable.

### SUMMARY OF THE INVENTION

It is therefore an object of this invention to provide an improved gearbox for a gas turbine engine.

In one aspect, the present invention provides a gearbox for a gas turbine engine comprising a gear shaft, a spiral bevel gear integral and concentric with the gear shaft, the spiral bevel gear having a negative helix angle, the gear shaft being driven by the gas turbine engine through the spiral bevel gear, and at least one additional gear connected to the gear shaft and meshed with a driven gear to drive at least one element of the gas turbine engine.

In another aspect, the present invention provides a method of manufacturing a gear shaft of a gas turbine engine gearbox, comprising forming at least a portion of the gear shaft with a gear body integral and concentric therewith, machining the gear body to obtain a bevel gear body, and machining the bevel gear body to define a spiral bevel gear having a negative helix angle.

In yet another aspect, the present invention provides a gas turbine engine comprising a compressor section driven by a central shaft, a combustor section in fluid communication with the combustor section, a turbine section in fluid communication with the combustor section and driving the central shaft, and a gearbox including a gear shaft driving at least one element of the gas turbine engine, the gear shaft having a spiral bevel gear with a negative helix angle integral and concentric therewith, the gear shaft being driven by the central shaft through the spiral bevel gear.

In a further aspect, the present invention provides a gear shaft for a gearbox, the gear shaft having a spiral bevel gear integral and concentric therewith with portions of the gear shaft extending from each side of the spiral bevel gear, the spiral bevel gear having a negative helix angle, each tooth of the spiral bevel gear extending along an arc of an imaginary circle defined outside of a cross-section of the gear shaft.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a schematic, cross-sectional view of a gas turbine engine;

FIG. 2 is a schematic, side view showing part of an accessory gearbox, in relation with a central shaft of a gas turbine engine such as shown in FIG. 1;

FIG. 3 is a schematic, side view of a gear shaft of the gearbox shown in δFIG. 2;

FIG. 4 is a schematic, front view of a gear shaft of the prior art; and

FIG. 5 is a schematic, front view of the gear shaft of FIG. 3.

### DETAILED DESCRIPTION OF THE PREFERRED EMBODIMENTS

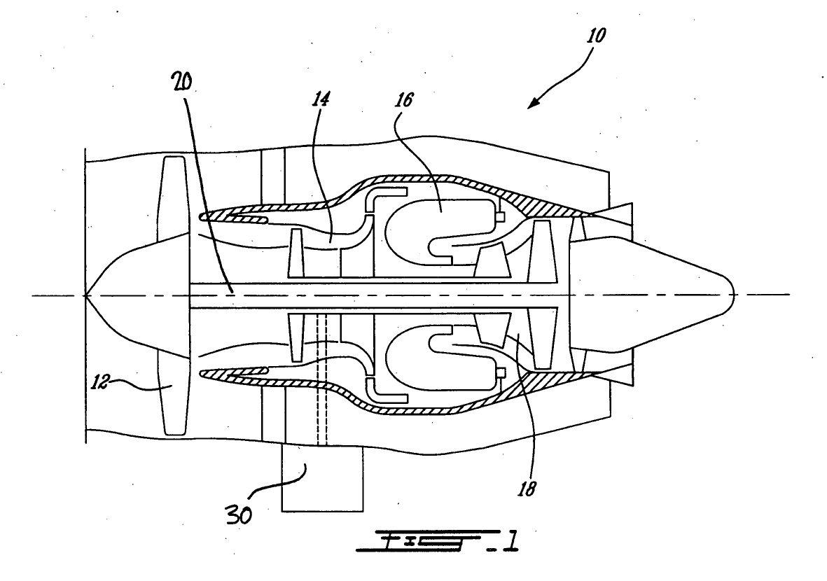

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The engine 10 includes a central shaft 20 which is driven by the turbine section 18 and which drives the compressor section 14.

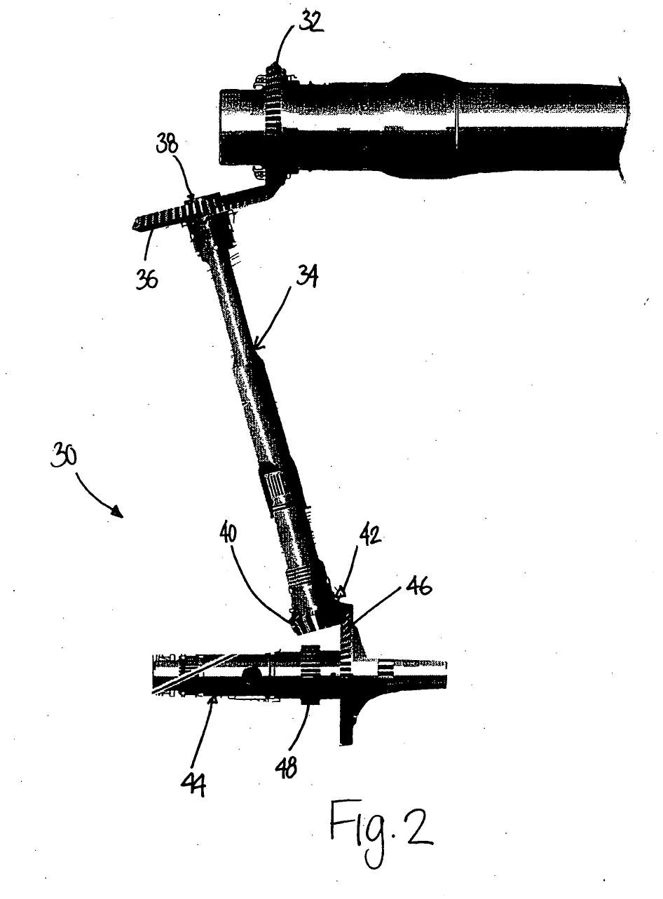

As schematically shown in FIG. 1, the gas turbine engine 10 also includes an accessory gearbox 30 which is driven by the central shaft 20 of the engine 10. Referring to FIG. 2, the central shaft 20 includes a gear 32 integral and concentric therewith. An inclined tower shaft 34 has a bevel gear 36 integral therewith at a first end 38 and a pinion 40 integral therewith at a second end 42. The bevel gear 36 of the tower shaft 34 meshes with the gear 32 of the engine's central shaft 20 such that the tower shaft 34 is driven by the central shaft 20.

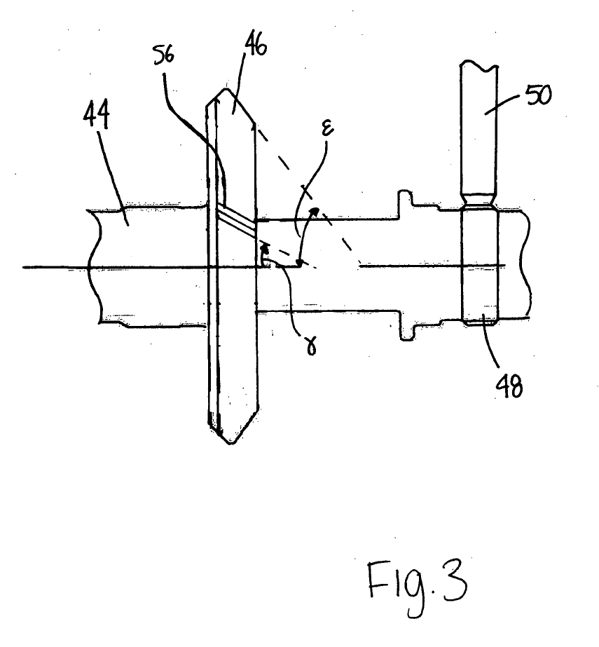

As can be seen in FIG. 3, the accessory gearbox 30 includes a starter gear shaft 44 having a spiral bevel gear 46 integral and concentric therewith, the bevel or pitch angle of the spiral bevel gear being shown as ε. The spiral bevel gear 46 is meshed with the pinion 40 of the tower shaft 34 such that the tower shaft 34 in turn drives the gear shaft 44 (see FIG. 2). The gear shaft 44 also includes at least one additional gear 48 which meshes with at least one accessory gear 50 to drive at least one accessory (not shown), such as for example a fuel pump, an oil pump, an hydraulic pump, a generator, an alternator, etc.

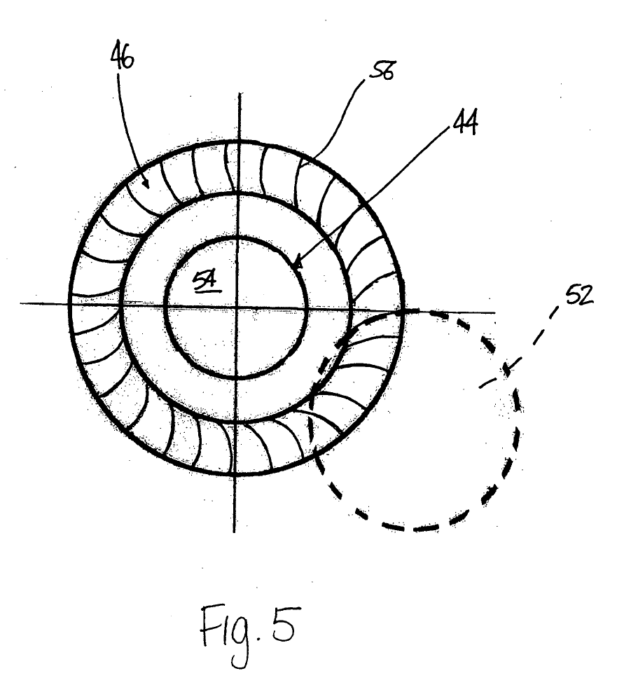

The spiral bevel gear 46 has a negative helix or spiral angle γ. Mating gears have to be compatible. Therefore, the negative helix or spiral angle of the bevel gear 46 is matched with a corresponding negative spiral angle of the mating pinion 40. As shown in FIG. 5, the negative helix angle γ allows the cutting and grinding tools 52, which are schematically shown in dotted lines, to remain outside of an area 54 defined by a cross-section of the starter gear shaft 44 while machining the spiral bevel gear 46. As such, the gear shaft 44 and spiral bevel gear 46 can be formed from a single piece of material, with portions of the gear shaft 44 protruding from each side of the spiral bevel gear 46, without interference between the machining tools 52 and the gear shaft 44.

As such, each tooth 56 of the spiral bevel gear 46 extends along an arc of a circle (represented by the circle 52 of the machining tool) which does not come into contact with the gear shaft 44, i.e. which is defined outside the cross-section 54 of the gear shaft 44.

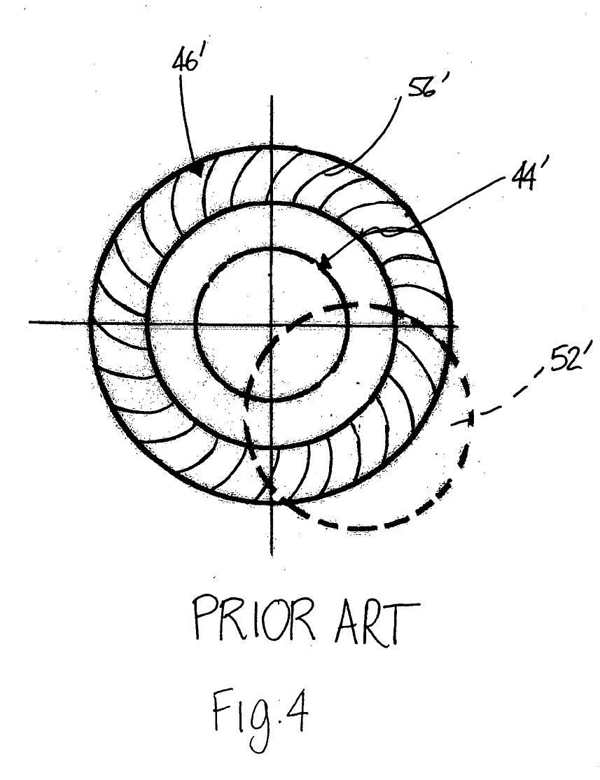

In a particular embodiment, the starter gear shaft 44 and spiral bevel gear 46 have relative dimensions similar to those shown in FIG. 4, i.e. relative dimensions that would cause interference of the machining tools 52 with the gear shaft 44 if the spiral bevel gear 46 had a positive helix angle γ as in the prior art.

The spiral angle of a negative gear=360 degrees—the spiral angle of an equivalent positive angle gear. Spiral angles ranging from 1 degree to up to 35 degrees are typically used for positive spiral angles, the equivalent negative spiral angles are 360 degrees−1 degree=359 degrees and 360 degrees−35 degrees=325 degrees. Accordingly, a typical range of negative spiral angle would be comprised between about 325 degrees to about 359 degrees.

In a particular embodiment, the gear shaft 44 and spiral bevel gear 46 are manufactured from a single piece which is formed to define the gear shaft 44 and a body of the spiral bevel gear 46. The gear body is then machined, using for example cutting and grinding tools 52 as is schematically illustrated in FIG. 5, to define the teeth of the spiral bevel gear 46 with the desired pitch angle ε and negative helix angle γ(see FIG. 3).

The integral gear shaft 44 and spiral bevel gear 46 made from a single piece of material allow for a lower cost of manufacture for the gearbox 30, as well as a better manufacturing accuracy through the elimination of the joint between the gear shaft 44 and the spiral bevel gear 46. The negative helix angle γ of the spiral bevel gear 46, through the elimination of the interference between the gear shaft 44 and the machining tools 52, reduces the risk of damaging the machining tools 52 and/or the gear shaft 44 through accidental contact therebetween when machining the spiral bevel gear 46.

The above description is meant to be exemplary only, and one skilled in the art will recognize that changes may be made to the embodiments described without department from the scope of the invention disclosed. For example, the starter gear shaft 44 and spiral bevel gear 46 can be used in other types of gearboxes for gas turbine engines. For instance, it could be used in a reduction gear box (RGB) of a turboprop engine. Still other modifications which fall within the scope of the present invention will be apparent to those skilled in the art, in light of a review of this disclosure, and such modifications are intended to fall within the appended claims.

What is claimed is:

1. A gearbox for a gas turbine engine comprising:
a gear shaft;
a spiral bevel gear integral and concentric with the gear shaft, the spiral bevel gear having a negative helix angle, the gear shaft being driven by the gas turbine engine through the spiral bevel gear; and
at least one additional gear connected to the gear shaft and meshed with a driven gear to drive at least one element of the gas turbine engine.

2. The gearbox as defined in claim 1, wherein the gear shaft is driven by the gas turbine engine by a tower shaft having a pinion meshed with the spiral bevel gear and a first gear meshed with a second gear integral with a central shaft of the gas turbine engine.

3. The gearbox as defined in claim 1, wherein the gear shaft and spiral bevel gear are formed of a single piece of material.

4. The gearbox as defined in claim 1, wherein the spiral bevel gear is positioned on the gear shaft such that a portion of the gear shaft protrudes from each side of the spiral bevel gear.

5. The gearbox as defined in claim 1, wherein the negative helix angle is equal to or greater than 325 degrees.

6. A method of manufacturing a gear shaft of a gas turbine engine gearbox, comprising:
forming at least a portion of the gear shaft with a gear body integral and concentric therewith;
machining the gear body to obtain a bevel gear body; and
machining the bevel gear body to define a spiral bevel gear having a negative helix angle.

7. The method as defined in claim 6, wherein forming at least the portion of the gear shaft with the gear body integral and concentric therewith includes machining a single piece of material to form the entire shaft and the gear body.

8. The method as defined in claim 6, wherein the gear body and the bevel gear body are machined by contacting at least one tool therewith, the at least one tool remaining outside of an area defined by a cross-section of the shaft.

9. The method as defined in claim 6, wherein the portion of the gear shaft and gear body are formed such that the portion of the gear shaft protrudes from each side of the gear body.

10. The method as defined in claim 6, wherein the bevel gear body is machined such that the negative helix angle is equal to or greater than 325 degrees.

11. A gas turbine engine comprising:
a compressor section driven by a central shaft;
a combustor section in fluid communication with the combustor section;
a turbine section in fluid communication with the combustor section and driving the central shaft; and
an accessory gearbox including a gear shaft driving at least one element of the gas turbine engine, the gear shaft having a spiral bevel gear with a negative helix angle integral and concentric therewith, the gear shaft being driven by the central shaft through the spiral bevel gear.

12. The gas turbine engine as defined in claim 11, wherein the gear shaft is driven by the central shaft by a tower shaft interconnecting a first gear meshed with a second gear of the central shaft and a pinion meshed with the spiral bevel gear.

13. The gas turbine engine as defined in claim 11, wherein the gear shaft and spiral bevel gear are formed of a single piece of material.

14. The gas turbine engine as defined in claim 11, wherein the spiral bevel gear is positioned on the gear shaft such that a portion of the gear shaft protrudes from each side of the spiral bevel gear.

15. The gas turbine engine as defined in claim 11, wherein the negative helix angle is equal to or greater than 325 degrees.

16. A gear shaft for a gearbox, the gear shaft having a spiral bevel gear integral and concentric therewith with portions of the gear shaft extending from each side of the spiral bevel gear, the spiral bevel gear having a negative helix angle, each tooth of the spiral bevel gear extending along an arc of an imaginary circle defined outside of a cross-section of the gear shaft.

17. The gear shaft as defined in claim 16, wherein the gear shaft and spiral bevel gear are formed from a single piece of material.

18. The gear shaft as defined in claim 16, wherein the negative helix angle is equal to or greater than 325 degrees.
